(19) United States
(12) Patent Application Publication
(10) Pub. No.: US 2004/0093359 A1
(43) Pub. Date: May 13, 2004

(54) Methods and apparatus for updating file systems

(76) Inventors: Edward J. Sharpe, Los Gatos, CA (US); Sushanth Rai, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/293,097

(22) Filed: Nov. 12, 2002

(51) Int. Cl. G06F 7/00

(52) U.S. Cl. 707/201

(57) ABSTRACT

A file system in a computer is disclosed. The file system is configured to service file access requests between an application program and a first data storage subsystem. The file system includes a first persistent module coupled to receive a first file access request. The first persistent module is associated with the first data storage subsystem. The first file access request pertains to the first data storage subsystem. The file system includes a first transparently unloadable module coupled to the first persistent module to service the first file access request. The first transparently unloadable module is configured to be dynamically unloadable from the computer, wherein the first persistent module includes a blocking arrangement for blocking the first file access request at the first persistent module to allow the first transparently unloadable module to be unloaded without causing an error in the application program. The first persistent module includes memory for storing data necessary to allow the first file access request to be serviced in a manner substantially transparent to the application program after a substitute transparently unloadable module associated with the first data storage subsystem is loaded in place of the first transparently unloadable module.

### BACKGROUND OF THE INVENTION

File systems have long been employed to manage interactions between applications and data storage facilities in a computer system. In most operating systems, such as UNIX, a file system is typically employed to, for example, manage the creation of and access to files and data storage facilities such as hard disks, CD-ROMs, network file systems (NFS), storage area networks (SANs), network assisted storage facilities (NAS); and the like.

To facilitate discussion, FIG. 1 illustrates the role of a file system in a typical operating system. Referring to FIG. 1, there is shown a plurality of users 102, 104, and 106. User 102 is shown executing two applications 110 and 112; user 104 is shown executing two applications, 114 and 116, while user 106 is shown executing an application 118. Application 110 employs files 120 and 122 during execution, which have respective file references 124 and 126 to storage locations in a storage subsystem 130. In general when a file is open, a file reference is established to the storage subsystem. The file reference persists until the file is closed. Opening a file, establishing a file reference to the storage subsystem, closing the file and the file reference are among the functions performed by the file system.

In FIG. 1, application 112 employs files 140 and 142 during execution. File references pertaining to files 140 and 142 to storage subsystem 130 are also managed by file system 132 in operating system 134. File references associated with files 150 and 152, which are employed by application 114, as well as the file reference for file 154, which is employed by application 116, are also managed by file system 132 of operating system 134. File 156, which is employed by application 118 during execution, also has its file reference to storage subsystem 130 managed by file system 132 of operating system 134. Although FIG. 1 shows only one data storage facility (storage subsystem 130) and an associated file system (file system 132), there may exist multiple storage subsystems in a typical computer system, as well as multiple file systems.

During operation, if file system 132 needs to be repaired and/or updated, file system 132 needs to be unmounted or otherwise taken off line. Because the file system and its associated data storage facility are unavailable to the applications during the time the file system is unmounted, all open files (and associated file references) handled by that file system must be closed.

For some applications the closure of an open file may require the application accessing that file be terminated all together. For example, applications that deal with log files and/or database files typically need to be terminated in order to close the open file(s). If an open file is not closed and an attempt to access the data storage subsystem associated with the unmounted file system is made during the time the file system is unmounted, a fatal error may result.

In the prior art, prior to unmounting the file system to facilitate repair and/or update, the system administrator would inform all users on the network of the impending unavailability of the file system and its associated data storage facilities. The system administrator then waits for users to terminate the files and/or applications in order to close the file references that employ the file system about to be unmounted.

If the user cannot be found, the system administrator may need to force the termination of files and/or applications. As in any situation where a termination is forced by a third party, the forced termination of user files and/or applications by the system administrator may cause data to be lost and/or aggravation to users. To minimize inconvenience to users, some system administrators elect to wait until the time when the number of users on the system may be small (e.g., 3:00 a.m. on Sunday morning) before attempting to unmount the file system. However, this approach may be impractical for computer networks in which there may be a large number of users present at any given point in time. For example, many electronic commerce applications executing via the internet may be accessible from anywhere around the world in any time zone and may, therefore, be in use around the clock every day. In these applications or networks, there may simply be no convenient time to unmount the file system.

Furthermore, unless the operating system has some inherent lock-out mechanism, waiting for all users to terminate may not be practical since users may continue to log on the system and may inadvertently cause file access requests to be made even before becoming aware that the system administrator had wished to close out all of the open files. Because of these difficulties, some system administrators deem it more prudent to simply shut down the entire computer system whenever a file system requires repair and/or update.

As can be expected, the termination of files and/or applications to facilitate update and/or repair to the file system represents a major inconvenience to the computer system users. For some applications, such as certain e-commerce applications for example, the termination of that application for any appreciable amount of time represents a major loss in revenue for the e-commerce merchant. Furthermore, the termination of a file and/or application is generally a time consuming process, requiring a non-trivial amount of time to orderly shut down the files and/or applications and to subsequently bring the files and/or applications back up on line after the file system has been repaired and/or updated. In many cases, the amount of time and/or work involved in shutting down and bringing back up a file, an application, or the entire computer system, may be very large compared to the amount of time required to actually repair and/or update the file system.

The same issues exist for file systems that are implemented as dynamic loadable kernel modules. As is well know, dynamic loadable kernel modules represent extension modules to the operating system, or more specifically to the file system therein, to enhance modularity and extensibility. To facilitate discussion, FIG. 2 is a schematic of a data storage architecture 200 in which file systems are implemented as dynamic loadable kernel modules. Referring to FIG. 2, there is shown a user applications block 202, representing the user applications. Operating system 210 includes a base operating system kernel layer 212 and an operating system extension layer 214. Base operating system kernel layer 212 includes a virtual file system 220 while operating system extension layer 214 includes a plurality of dynamic loadable kernel modules 222, 224, and 226. Line 236 conceptually separates the user space from the kernel space associated with operating system 210. Via virtual file system 220 and the dynamic loadable kernel modules 222, 224, and 226, user applications in user applications block 202 can access a plurality of data storage subsystems, which are represented in the example of FIG. 2 by a hard disk 230, a network file system 232, and a CD-ROM 234.

Virtual file system 220 supports multiple individual file systems implemented as dynamic loadable kernel modules and contains the abstraction of the individual file systems so that the applications in user applications block 202 can make high-level calls (such as read, write, seek, open, load, and the like) without having to know the specifics of the individual file systems.

Each dynamic loadable kernel module in OS extension layer 214 contains the bulk of the functionalities specific to the data storage subsystem it controls. Generally speaking, OS extension layer 214 is regarded as an extension layer because the individual file systems do not reside entirely in the base OS kernel layer 212 but are instead supplied as dynamic loadable kernel modules and can be linked to extend the functionality of operating system 210. Implementing at least a portion of the file system in dynamic loadable kernel modules is a common way to implement a file system because such implementation promotes modularity, data abstraction, and scalability with respect to operating system 210.

As mentioned earlier, even if the file system is implemented with dynamic loadable kernel modules, similar issues exist. That is, the file system still needs to be unmounted, and the individual dynamic loadable kernel module to be repaired and/or updated (such as hierarchical file system dynamic loadable kernel module 222) needs to be unloaded. During this time, the data storage subsystem associated with the unloaded dynamic loadable kernel module is still inaccessible. Any attempt to access the data storage subsystem via the unloaded dynamic loadable kernel module would result in a severe and often fatal error to the application attempting to make the offending file access.

### SUMMARY OF THE INVENTION

The invention relates, in one embodiment, to a computer-implemented method for maintaining a file system. The file system is configured to service file access requests between an application program and a first data storage subsystem. The file system includes a first persistent module and a first transparently unloadable module. The first persistent module and the first transparently unloadable module are associated with the first data storage subsystem. The method includes blocking, using the first persistent module, a first file access request made by the application program to the first data storage subsystem. The blocking step includes maintaining information pertaining to the first file access request at the first persistent module. The method also includes unloading the first transparently unloadable module, which renders file access functionalities in the transparently unloadable module inaccessible to the first persistent module. The method additionally includes loading a first substitute transparently unloadable module to render file access functionalities in the first substitute transparently unloadable module accessible to the first persistent module. The first substitute transparently unloadable module is associated with the first data storage subsystem after the loading, wherein the first file access request made by the application program to the first data storage subsystem does not cause a generation of an error condition with respect to the application program while the first transparently unloadable module is unloaded and wherein the unloading of the first transparently unloadable module and the loading of the substitute transparently unloadable module are made without rebooting a computer associated with the file system.

In another embodiment, the invention relates to a file system in a computer. The file system is configured to service file access requests between an application program and a first data storage subsystem. The file system includes a first persistent module coupled to receive a first file access request. The first persistent module is associated with the first data storage subsystem. The first file access request pertains to the first data storage subsystem. The file system includes a first transparently unloadable module coupled to the first persistent module to service the first file access request. The first transparently unloadable module is configured to be dynamically unloadable from the computer, wherein the first persistent module includes a blocking arrangement for blocking the first file access request at the first persistent module to allow the first transparently unloadable module to be unloaded without causing an error in the application program. The first persistent module includes memory for storing data necessary to allow the first file access request to be serviced in a manner substantially transparent to the application program after a substitute transparently unloadable module associated with the first data storage subsystem is loaded in place of the first transparently unloadable module.

In yet another embodiment, the invention relates to a file system in a computer for servicing file access requests between an application program and a first data storage subsystem. The file system includes a first persistent module having means for blocking a first file access request for the first data storage subsystem and means for storing first data associated with the first file access request at the first persistent module. The file system also includes a first transparently unloadable module coupled to the first persistent module to service the first file access request. The first transparently unloadable module is configured to be dynamically unloadable from the computer, wherein the means for blocking blocks the first file access request at the first persistent module prior to unloading the first transparently unloadable module to allow the first transparently unloadable module to be unloaded without causing an error in the application program, and wherein the first data includes data necessary to allow the first file access request to be serviced in a manner substantially transparent to the application program after a substitute transparently unloadable module associated with the first data storage subsystem is loaded in place of the first transparently unloadable module.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates the role of a file system in a typical operating system.

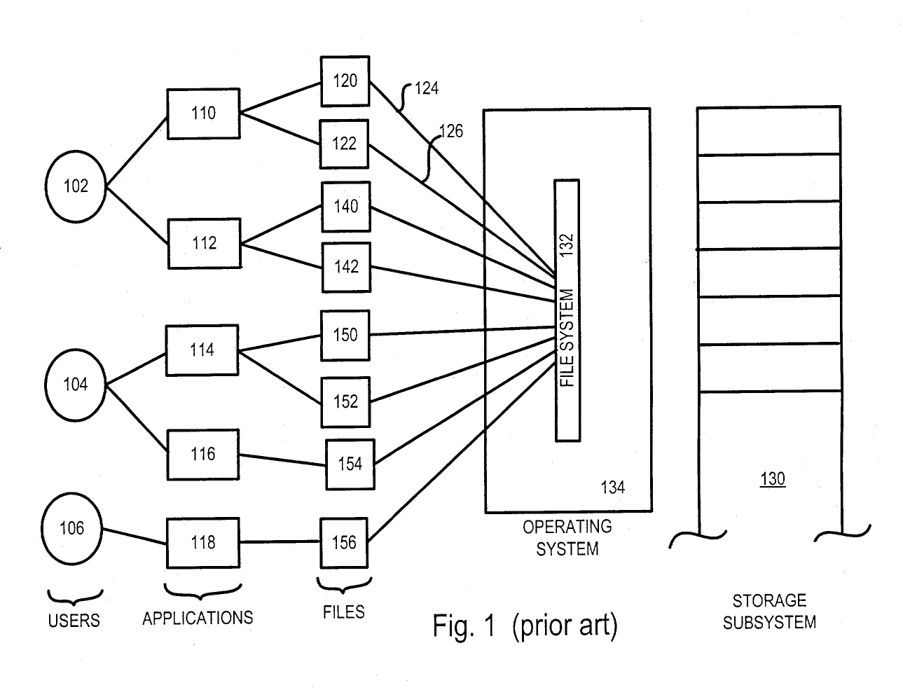

FIG. 2 is a schematic of a data storage architecture in which dynamic loadable kernel modules are employed.

FIG. 3 shows, in accordance with one embodiment of the present invention, a data storage architecture that allows the file system to be updated without requiring its unmounting.

FIG. 4 shows, in accordance with one embodiment of the present invention, a flow chart illustrating the relevant steps in repairing and/or updating an individual file system without requiring the unmounting of the entire file system and/or the termination of applications/files that may make file system calls thereto.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In accordance with one embodiment of the present invention, there are provided methods and apparatus for allowing the file system to be repaired and/or updated in a manner that is substantially transparent to the user applications. That is, the file system can be repaired and/or updated without requiring the closing of files and/or termination of applications that access that file system or the closing of files and/or termination of applications that access the specific individual file system that requires the updating/repairing. In one embodiment, the operating system extension layer (also known as file dependent layer) is divided into two layers: a persistent layer and a transparently unloadable layer. Thus, the overall file system now has three components: a virtual file system component, which contains the abstractions of the various individual file systems to allow applications to make high level calls to the individual file systems; a plurality of persistent modules in the persistent layer; and a plurality of transparently unloadable modules (TUMs) in the transparently unloadable layer. Together, these three components manage interactions between the application programs and the data storage subsystems.

The persistent module associated with a given data storage subsystem contains a blocking mechanism that blocks and queues file access requests pertaining to its associated data storage subsystem when its associated transparently unloadable module is unloaded for repair and/or update. Preferably, the persistent module contains state or management data, such as the data that needs to be maintained in the operating system to facilitate file system interaction with the application program in the current session. This state or management data represents the data that needs to persist between the unloading and loading of the transparently unloadable module. Examples of the state and/or management data includes such information as the time of last access, the time the file is opened, the current file position, the current size, the location of data in cache, and the like.

From the perspective of the application program making the file access request, no error would be experienced. Instead the file access request is merely temporarily blocked and queued up at the associated persistent module. After being repaired and/or updated, the transparently unloadable module is loaded, and the file access requests earlier blocked and/or queued up at the associated persistent module are then serviced. In this manner, there is no need to close the files and/or terminate the applications prior to unloading the individual transparently unloadable module for repair and/or update. Furthermore, there is no need to unmount the file system itself. During the time that a transparently unloadable module of an individual file system is unloaded, no error would be experienced by the application program making the file access request via the unloaded individual file system.

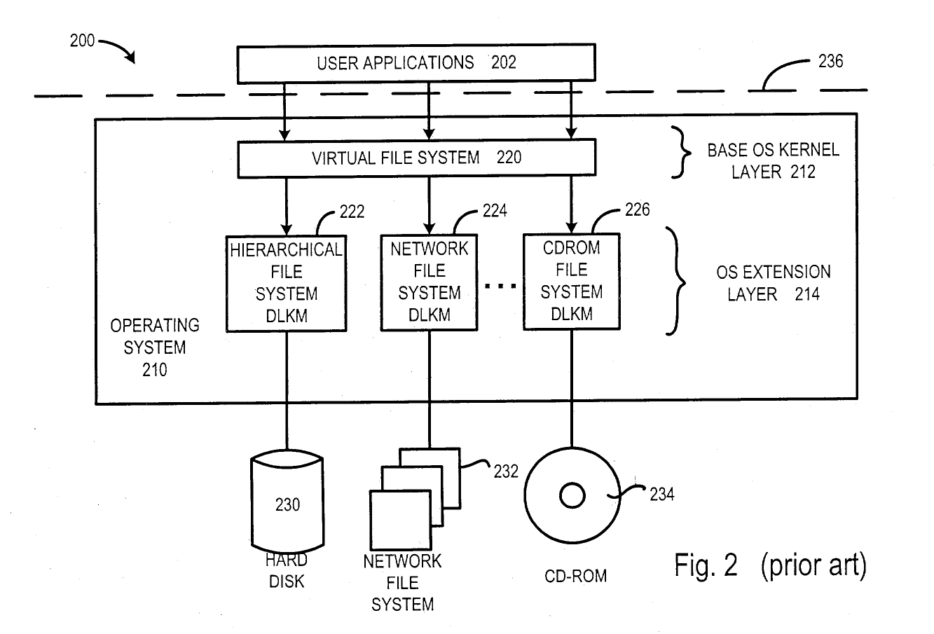

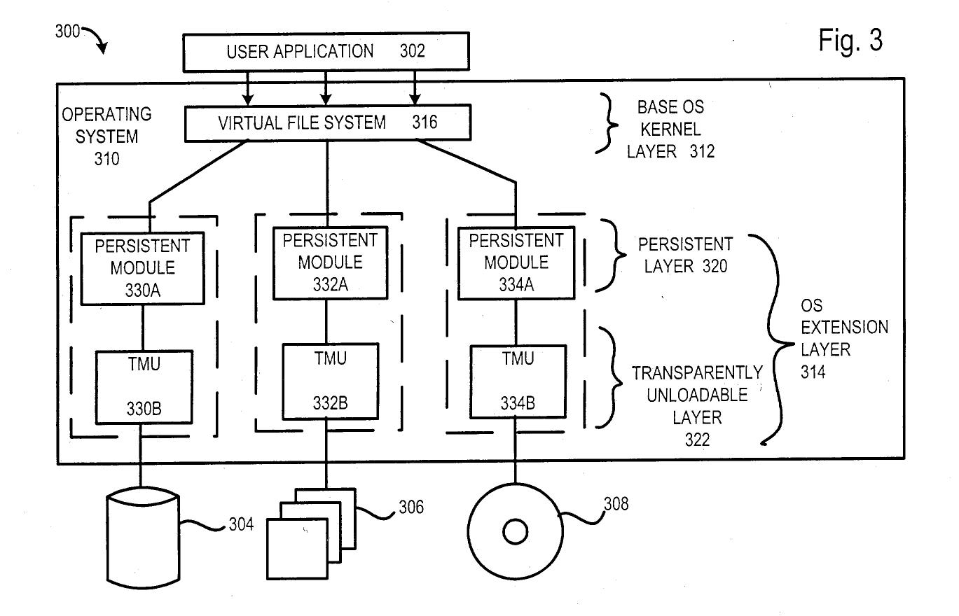

The features and advantages of the present invention may be better understood with reference to the figures and discussion that follow. FIG. 3 shows a data storage architecture 300 in which applications in user applications block 302 can access a plurality of data storage subsystems such as a hard disk 304, a network file system 306, and a CD-ROM 308 via operating system 310. Operating system 310 includes a base OS kernel layer 312 and an OS extension layer 314. Base OS kernel layer 312 is analogous to base OS kernel layer 212 of FIG. 2, and includes a virtual file system 316. As before, virtual file system 316 supports a plurality of individual file systems and contains abstractions of the individual file systems such that a user applications in user applications block 302 can make high level calls (such as read, write, seek, open, load, and the like) to the individual file systems without having to know the specifics of the individual file systems.

OS extension layer 314 includes, in one embodiment a persistent layer 320 and a transparently unloadable layer 322. In another embodiment, the persistent layer 320 may be part of the Base OS kernel layer 312. Each individual file system dependent module or OS extension module associated with an individual file system now contains two modules, one of which resides in persistent layer 320 and the other in transparently unloadable layer 322. For example, the individual file system dependent module associated with hard disk 304 now includes a persistent module 330A and a transparently unloadable module 330B. Persistent module 330A and transparently unloadable module 330B, together with virtual file system 316, facilitate the interactions between user applications in user applications block 302 and hard disk 304. Likewise, persistent module 332A and transparently unloadable module 332B, together with virtual file system 316, facilitate interactions between user applications in user applications block 302 and network file system 306. Likewise, persistent module 334A and transparently unloadable module 334B, together with file system 316, facilitate interactions between user applications in user applications block 302 and CD-ROM 308. Of course, there may be as many pairs of persistent module/transparently unloadable module in the OS extension layer as there are data storage subsystems or other subsystems to be controlled and/or monitored.

The transparently unloadable module represents the module that implements the bulk of the functionalities specific to a given individual file system. A persistent module, such as persistent module 330A, only allows file system calls to its associated data storage subsystem (such as hard disk 304) to proceed only if its associated transparently unloadable module 330B is not unloaded. If its associated transparently unloadable module 330B is unloaded, persistent module 330A will block file system calls at persistent layer 320 and will keep track of the temporarily blocked file system calls therein.

When transparently unloadable module 330B is loaded and its functionalities become available again, the blocked file system calls will be unblocked and serviced again in a manner that is substantially transparent to the user application making the original file system calls. This is quite unlike the situation in the prior art in which applications/files are terminated prior to the unmounting/unloading of the file system, and one must start up the application and/or open the file(s) again and synched up again after file system is mounted and loaded. In the current invention, applications simply proceed and the temporarily blocked file system calls would be serviced by the individual file system when the functionalities in the associated transparently unloadable module become available again. In some cases, there may be a small delay which, depending on system performance, may be hardly noticeable to the user. However, this is greatly more preferable than an error message or a fatal error, or having to reopen a file, start up an application program, and/or the computer system, as would happen in the prior art.

In some cases, the substitute TUM data format may differ from that of the old TUM, e.g., when there is a significant functional change between the old TUM and the new TUM. In these situations, the newly loaded TUM may update the persistent data structure in the persistent layer before resuming operation. This update may happen all at once for all persistent layer data impacted by the new TUM or may take place over time on an as-needed basis.

Persistent module 330A, as well as other persistent modules in persistent layer 320, preferably maintains the state or management data that needs to be kept track of between the unloading and loading of its associated transparently unloadable module. This state or management data may be kept in volatile or nonvolatile memory and includes, as mentioned earlier, the data that needs to be maintained in the operating system to facilitate file system interaction for the current session between the user applications and the affected data storage subsystem. Exemplary state or management data may include information pertaining to time of last access, the time the file is opened, the current file position, the current size of the file, the location of the file data in the cache, and the like. Note that in the prior art, no management/state data is kept after the unmounting and unloading of the file system because all open files would have been terminated prior to such unmounting and unloading, and there was thus no need to keep track of the state or management data.

If an individual file system needs to be repaired and/or updated, and there is state or management data in the transparently unloadable module, this state or management data is transferred back, in accordance with one embodiment of the present invention, to the associated persistent module in the persistent layer prior to the unloading of the transparent unloadable module. For example, the state or management data may reside in the transparently unloadable module of some systems if there is a pending call for a remote data storage subsystem that has taken a long time to complete. In this case, the pending call is held in the transparently unloadable module and would preferably be transferred back, along with any state and/or management data, to the persistent module prior to the unloading of the associated transparently unloadable module. By allowing the pending file system call and/or the state/management data to revert back to the persistent module, the associated transparently unloadable module may be unloaded more quickly, and repair and/or update may proceed faster without having to wait for the current file service call to complete.

Alternatively, the normal operation of the TUM may be to hold no such state information upon detecting that an operation may take a long time to complete.

Instead, the TUM may transfer, as part of its normal operation, any related state information to the persistent layer upon such detection. Accordingly, there may be no need to transfer the state information to the persistent layer when it comes time to unload the TUM.

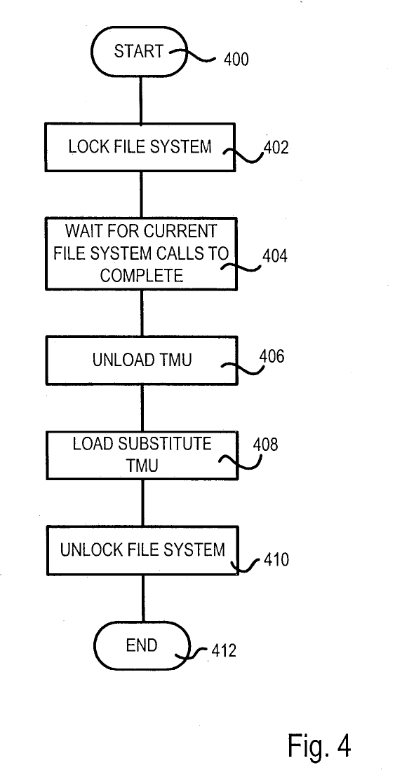

FIG. 4 shows, in accordance with one embodiment of the present invention, a flow chart illustrating the relevant steps in repairing and/or updating an individual file system without requiring the unmounting of the entire file system and/or the termination of applications/files that may make file system calls thereto. In step 402, the individual file system about to be unloaded is locked to prevent additional file system calls to be forwarded from the associated persistent module to the associated transparently unloadable module. In other words, locking the affected individual file system (step 402) essentially causes subsequent file system calls to the individual file system about to be unloaded to be temporarily blocked and queued in the associated persistent module in the persistent layer.

With reference to FIG. 3, if the individual file system associated with CD ROM 308 needs to be updated and/or repaired, the individual file system is locked at persistent layer 320, in persistent module 334A. Note that from the perspective of the user application in user applications block 302 of FIG. 3, the individual file system associated with CD-ROM 308 still appears to be available and file system calls can still be made to CD-ROM 308 (but not serviced immediately) without causing a severe or fatal error. Furthermore, since the transparently unloadable module may be dynamically unloaded and loaded on a per individual file system basis, file system calls to other individual file systems (such as those associated with network file system 306 or hard disk 304) may proceed as normal.

In step 404, the current file system calls are allowed to complete prior to the unloading of the transparently unloadable module. As mentioned earlier, if it may take some time to complete the current file system call, the file system call and the associated state/management data may be transferred back to the associated persistent module in the persistent layer and maintained therein to allow the transparently unloadable module to be unloaded and serviced quicker. In step 406 the transparently unloadable module is unloaded.

In step 408 the substitute transparently unloadable module is loaded. This substitute transparently unloadable module represents the transparently unloadable module after update and/or repair. Thus, the transparently unloadable module in Step 408 may represent that same module unloaded in step 406 after the update/repair is performed, or it may represent a new transparently unloadable module altogether. In step 410 the individual file system is unlocked. Unlocking the individual file system has the effect of allowing file system calls, including any file system calls temporarily blocked in the persistent layer during the time the transparently unloadable module is unloaded, to be unblocked and serviced.

As can be appreciated from the foregoing, the invention advantageously allows the file system and, more particularly, the individual file system associated with a specific data storage subsystem to be updated and/or repaired without requiring the unmounting of the entire file system. Also, the file system can be updated and/or repaired without shutting down the entire computer system or requiring the termination of the files/applications that may make file system calls to the affected data storage subsystem.

Because of the blocking capability in the persistent module, user applications can continue in a substantially transparent manner and file service calls are simply temporarily blocked or queued at the persistent module without causing a severe and/or fatal error. Thus users can continue to use the computer system for operations and/or to conduct transactions. This is particularly advantageous for applications such as Internet e-commerce applications where any interruption is highly costly for the e-commerce merchant. The invention also improves the availability of the computer system to users since the lengthy shutdown/restart cycles for the computer system itself, or for applications, is eliminated when an individual file system needs to be repaired and/or updated.

Furthermore, the system administrator does not have to be burdened with the task of informing users that they need to close out files or terminate applications, or to have to undertake the task of forcing the termination thereof, in order to accomplish individual file system repair and/or update. With the ability to temporarily block file system calls to the affected individual file system, the system administrator does not need to wait until the early hours of the morning, or the time when usage is light, before undertaking the task of repairing and/or updating individual file systems. Additionally, with the ability to revert pending file system calls and state/management data back to the persistent layer, the invention also allows the system administrator, if he so desires, to more quickly begin the task of repairing/updating the transparently unloadable module without having to wait until all pending file system calls are completed.

While this invention has been described in terms of several preferred embodiments, there are alterations, permutations, and equivalents which fall within the scope of this invention. For example, although the specific exemplary implementation discussed herein positions the persistent layer and/or the TUM layer in the OS kernel space, the invention also applies to situations where the persistent layer and/or the TUM layer are implemented in the user/application space or in a combination thereof. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A computer-implemented method for maintaining a file system, said file system being configured to service file access requests between an application program and a first data storage subsystem, said file system including a first persistent module and a first transparently unloadable module, said first persistent module and said first transparently unloadable module being associated with said first data storage subsystem, comprising:
blocking, using said first persistent module, a first file access request made by said application program to said first data storage subsystem, said blocking including maintaining information pertaining to said first file access request at said first persistent module;
unloading said first transparently unloadable module, said unloading rendering file access functionalities in said transparently unloadable module inaccessible to said first persistent module; and
loading a first substitute transparently unloadable module to render file access functionalities in said first substitute transparently unloadable module accessible to said first persistent module, said first substitute transparently unloadable module being associated with said first data storage subsystem after said loading,
wherein said first file access request made by said application program to said first data storage subsystem does not cause a generation of an error condition with respect to said application program while said first transparently unloadable module is unloaded and wherein said unloading of said first transparently unloadable module and said loading of said substitute transparently unloadable module are made without rebooting a computer associated with said file system.

2. The computer-implemented method of claim 1 wherein further comprising:
servicing said first file access request, employing said first substitute transparently unloadable module and said information pertaining to said first file access request that is maintained by said first persistent module, after said first substitute transparently unloadable module is loaded.

3. The computer-implemented method of claim 1 wherein said file system is part of an operating system of a computer and said first transparently unloadable module is a dynamically linkable module that is linkable by said operating system.

4. The computer-implemented method of claim 3 wherein said operating system is Unix-based.

5. The computer-implemented method of claim 3 wherein said operating system is Windows-based.

6. The computer-implemented method of claim 3 wherein said operating system is Linux-based.

7. The computer-implemented method of claim 3 wherein said first persistent module is disposed in a kernel space of said operating system.

8. The computer-implemented method of claim 3 wherein said first persistent module is disposed in an application space of said operating system.

9. The computer-implemented method of claim 1 further comprising transferring first data from said first transparently unloadable module to said first persistent module prior to said unloading, said first data being associated with a second file access request that is awaiting to be serviced at said first transparently unloadable module, said first data including at least a subset of the information necessary to substantially transparently service said second file access request after said substitute transparently unloadable module is loaded.

10. The computer-implemented method of claim 1 further comprising blocking a second file access request at said first persistent module, said second file access request being made by said application program after said first transparently unloadable module is unloaded but before said substitute transparently loadable module is loaded.

11. In a computer, a file system configured to service file access requests between an application program and a first data storage subsystem, said file system comprising:
a first persistent module coupled to receive a first file access request, said first persistent module being associated with said first data storage subsystem, said first file access request pertains to said first data storage subsystem; and
a first transparently unloadable module coupled to said first persistent module to service said first file access request, said first transparently unloadable module being configured to be dynamically unloadable from said computer, wherein said first persistent module includes a blocking arrangement for blocking said first file access request at said first persistent module to allow said first transparently unloadable module to be unloaded without causing an error in said application program, said first persistent module includes memory for storing data necessary to allow said first file access request to be serviced in a manner substantially transparent to said application program after a substitute transparently unloadable module associated with said first data storage subsystem is loaded in place of said first transparently unloadable module.

12. The file system of claim 11 wherein said computer further includes a virtual file system, said first persistent module being coupled to said virtual file system to receive said first file access request from said virtual file system.

13. The file system of claim 11 wherein said first transparently unloadable module is implemented as a dynamically linkable module that is linkable by an operating system of said computer.

14. The file system of claim 13 wherein said operating system is Unix-based.

15. The file system of claim 13 wherein said first persistent module is disposed in a kernel space of said operating system.

16. The file system of claim 13 wherein said first persistent module is disposed in an application space of said operating system.

17. The file system of claim 11 further comprising an arrangement associated with said first transparently unloadable module for transferring first data from said first transparently unloadable module to said first persistent module prior to unloading said first transparently unloadable module, said first data being associated with a second file access request that is awaiting to be serviced at said first transparently unloadable module, said first data includes at least a subset of the information necessary to substantially transparently service said second file access request after said substitute transparently unloadable module is loaded.

18. A file system in a computer for servicing file access requests between an application program and a first data storage subsystem, comprising:
a first persistent module having means for blocking a first file access request for said first data storage subsystem and means for storing first data associated with said first file access request at said first persistent module; and
a first transparently unloadable module coupled to said first persistent module to service said first file access request, said first transparently unloadable module being configured to be dynamically unloadable from said computer, wherein said means for blocking blocks said first file access request at said first persistent module prior to unloading said first transparently unloadable module to allow said first transparently unloadable module to be unloaded without causing an error in said application program, and wherein said first data includes data necessary to allow said first file access request to be serviced in a manner substantially transparent to said application program after a substitute transparently unloadable module associated with said first data storage subsystem is loaded in place of said first transparently unloadable module.

19. The file system of claim 18 wherein said first transparently unloadable module is implemented as a dynamically linkable module that is linkable by an operating system of said computer.

20. The file system of claim 18 further comprising an arrangement associated with said first transparently unloadable module for transferring second data from said first transparently unloadable module to said first persistent module prior to unloading said first transparently unloadable module, said second data being associated with a second file access request that is awaiting to be serviced at said first transparently unloadable module, said second data includes at least a subset of the information necessary to substantially transparently service said second file access request after said substitute transparently unloadable module is loaded.

21. The file system of claim 18 wherein said first persistent module is disposed in a kernel space of an operating system of said computer.
